(19) United States
(12) Patent Application Publication
(10) Pub. No.: US 2026/0371136 A1
(43) Pub. Date: Nov. 19, 2026

(54) MEASUREMENT REPORTING METHOD AND APPARATUS, AND DEVICE, SYSTEM AND MEDIUM

(71) Applicant: Beijing Xiaomi Mobile Software Co., Ltd., Beijing (CN)

(72) Inventor: Xing YANG, Beijing (CN)

(21) Appl. No.: 19/478,230

(22) PCT Filed: Apr. 24, 2023
(86) PCT No.: PCT/CN2023/090432

§ 371 Date: Oct. 23, 2025

(51) Int. Cl. H04W 24/10; H04L 41/16

(52) U.S. Cl. CPC H04W 24/10; H04L 41/16

(57) ABSTRACT

A method for reporting a measurement, including: obtaining a first measurement result, where the first measurement result is a measurement result of a first target; predicting a second measurement result according to the first measurement result, where the second measurement result is a measurement result of a second target; and sending the second measurement result to a network device.

### CROSS-REFERENCE TO RELATED APPLICATION

The present application is a U.S. National Stage of International Application No. PCT/CN2023/090432, filed on Apr. 24, 2023, the contents of all of which are incorporated herein by reference in their entirety for all purposes.

### BACKGROUND OF THE INVENTION

A user equipment measures a cell. During the measurement process, the user equipment needs to obtain a measurement result of a target cell by receiving a reference signal sent by the target cell.

### SUMMARY OF THE INVENTION

The present disclosure relates to the technical field of communications, and in particular, to a method and device for reporting a measurement, a device, a system, and a medium.

According to a first aspect of the embodiments of the present disclosure, a method for reporting a measurement is provided. The method is performed by a user equipment and includes:
obtaining a first measurement result, where the first measurement result is a measurement result of a first target;
predicting a second measurement result according to the first measurement result, where the second measurement result is a measurement result of a second target; and
sending the second measurement result to a network device.

According to a second aspect of the embodiments of the present disclosure, a method for reporting a measurement is provided. The method is performed by a network device and includes:
receiving a second measurement result sent by a user equipment, where the second measurement result is predicted according to a first measurement result, the first measurement result is a measurement result of a first target, and the second measurement result is a measurement result of a second target.

According to a third aspect of the embodiments of the present disclosure, user equipment is provided, including:
one or more processors; and
a memory that stores processor-executable instructions;
where the processor-executable instructions, when collectively executed by the one or more processors, cause the user equipment to perform the method for reporting a measurement according to the first aspect of the embodiments of the present disclosure.

According to a fourth aspect of the embodiments of the present disclosure, a network device is provided, including:
one or more processors; and
a memory that stores processor-executable instructions;
where the processor-executable instructions, when collectively executed by the one or more processors, cause the network device to perform the method for reporting a measurement according to the second aspect of the embodiments of the present disclosure.

According to a fifth aspect of the embodiments of the present disclosure, a non-transitory computer-readable storage medium is provided. The non-transitory computer-readable storage medium stores computer program instructions, where the computer program instructions, when collectively executed by one or more processors, implement the method for reporting a measurement according to the first aspect or the second aspect of the embodiments of the present disclosure.

It is to be understood that the general description above and the detailed description below are merely examples and illustrative, and are not intended to limit the present disclosure.

### BRIEF DESCRIPTION OF DRAWINGS

The above and/or additional aspects and benefits of the present disclosure become apparent and readily understood from the following description of the embodiments with reference to the accompanying drawings.

FIG. 1 is a schematic diagram of a communication system according to some embodiments.

FIG. 2 is a flowchart of a method for reporting a measurement according to some embodiments.

FIG. 3 is a flowchart of a method for reporting a measurement according to some embodiments.

FIG. 4 is a flowchart of a method for reporting a measurement according to some embodiments.

FIG. 5 is a flowchart of a method for reporting a measurement according to some embodiments.

FIG. 6 is a flowchart of a method for reporting a measurement according to some embodiments.

FIG. 7 is a flowchart of a method for reporting a measurement according to some embodiments.

FIG. 8 is a flowchart of a method for reporting a measurement according to some embodiments.

FIG. 9 is a flowchart of a method for reporting a measurement according to some embodiments.

FIG. 10 is a block diagram of a device for reporting a measurement according to some embodiments.

FIG. 11 is a block diagram of a device for reporting a measurement according to some embodiments.

FIG. 12 is a block diagram of a user equipment according to some embodiments.

FIG. 13 is a block diagram of a network device according to some embodiments.

### DETAILED DESCRIPTION OF THE INVENTION

Embodiments of the present disclosure propose a “method for reporting a measurement”. In some embodiments, “a method for reporting a measurement” may be interchanged with terms such as “a method for sending a measurement result,” “a method for receiving a measurement result,” and “a measurement method,” and “a device for reporting a measurement” may be interchanged with terms such as “a device for sending a measurement result,” “a device for receiving a measurement result,” and “a measurement device”.

The embodiments of the present disclosure are not exhaustive, are merely illustrative of some embodiments, and are not intended to specifically limit the protection scope of the present disclosure. Each step in a certain embodiment may be implemented as an independent embodiment, and various steps may be combined arbitrarily, in a case of no contradiction. For example, a solution with some steps removed in a certain embodiment may also be implemented as an independent embodiment, and the order of the steps in a certain embodiment may be exchanged arbitrarily. In addition, optional implementations in a certain embodiment may be combined arbitrarily. Furthermore, various embodiments may be combined arbitrarily. For example, some or all of the steps of different embodiments may be combined arbitrarily, and a certain embodiment may be combined with optional implementations in other embodiments.

Terms used in the embodiments of the present disclosure are merely for the purpose of describing specific embodiments, and are not intended to limit the present disclosure. Singular forms such as “one,” “a/an,” “this,” “the above,” “the,” “the forgoing,” and “the one” as used in the embodiments of the present disclosure also include plural forms, unless the context clearly indicates otherwise. Predefinition in the embodiments of the present disclosure may be understood as definition, preliminary definition, storage, pre-storage, pre-negotiation, pre-configuration, solidification, or pre-burning.

In the embodiments of the present disclosure, prefixes such as “first” and “second” are merely for distinguishing different described objects, and do not limit the positions, order, priorities, quantity, or content of described objects. For example, ordinal numbers before “fields” in a “first field” and a “second field” do not limit the position or order between the “fields,” in a case where the described object is a “field”. “First” and “second” do not limit whether their modified “fields” are in the same message, or the order of the “first field” and the “second field”. For another example, ordinal numbers before “levels” in a “first level” and a “second level” do not limit the priority between the “levels,” in a case where the described object is a “level”. For another example, the quantity of the described objects is not limited by ordinal numbers and may be one or more. Taking a “first device” as an example, the quantity of “devices” may be one or more. In addition, objects modified by different prefixes may be the same or different. For example, a “first device” and a “second device” may be the same type of device or different types of devices, in a case where the described object is a “device”. For another example, “first information” and “second information” may be information with the same content or different contents, in a case where the described object is “information”. In summary, the use of ordinal numbers and other prefixes used in the embodiments of the present disclosure to distinguish the described objects does not constitute any limitation on the described objects. For statements about the described objects, refer to the claims or the descriptions of the context in the embodiments, and the use of such prefixes is not expected to constitute any redundant limitations.

“A plurality of” in the embodiments of the present disclosure refers to two or more. In the embodiments of the present disclosure, “and/or” is configured to describe an association relationship between associated objects, indicating three relationships that may exist independently. For example, “A and/or B” may indicate the following three cases: A exists alone, B exists alone, or both A and B exist. The description, such as “at least one (or at least one, at least one item) of A1, A2, . . . , and An,” used in the embodiments of the present disclosure includes a case where any one of A1, A2, . . . , and An exists alone, as well as any combination of any plurality of A1, A2, . . . , and An. Each case may exist independently. For example, the description “at least one of A, B, or C” includes cases of A alone, B alone, C alone, a combination of A and B, a combination of A and C, a combination of B and C, or a combination of A, B, and C.

In some embodiments, phrases such as “in one case, A, and in another case, B” and “in response to one case, A, and in response to another case, B” may include the following technical solutions depending on the situation: executing A regardless of B, i.e., A in some embodiments; executing B regardless of A, i.e., B in some embodiments; selectively executing A and B, i.e., selecting from A and B for execution in some embodiments; and executing both A and B, i.e., A and B in some embodiments. The same applies when there are more branches, such as A, B, C, etc.

In some embodiments, the terms “in response to . . . ,” “in response to determining . . . ,” “in a case where . . . ,” “upon . . . ,” “when . . . ,” “in a case of . . . ,” and “if . . . ” may be interchanged.

In some embodiments, “including A,” “containing A,” “configured to indicate A,” and “carrying A” may be interpreted as directly carrying A or indirectly indicating A.

In some embodiments, the terms such as “greater than,” “greater than or equal to,” “above,” “higher than,” and “not less than” may be interchanged, and the terms such as “less than,” “less than or equal to,” “below,” “lower than,” and “not greater than” may be interchanged.

In some embodiments, the terms “radio,” “wireless,” “radio access network (RAN),” “access network (AN),” and “RAN-based” may be interchanged.

In some embodiments, “predetermined” and “preset” may be interpreted as being pre-specified in a protocol or as an action preset by a device, etc.

In some embodiments, a device and the like may be interpreted as a physical or virtual entity, and its name is not limited to those recorded in the embodiments. The terms such as “apparatus,” “equipment,” “device,” “network element,” “node,” “function,” “unit,” “entity,” “system,” “chip,” “chip system,” and “body” may be interchanged.

In some embodiments, a name of information and the like are not limited to those recorded in the embodiments, and the terms such as “information,” “message,” “signaling,” “report,” “configuration,” “indication,” “parameter,” and “data” may be interchanged.

In some embodiments, the terms such as “instruction” and “program” may be interchanged.

In some embodiments, the terms “acquire,” “obtain,” “get,” “receive,” and “transmit (send and/or receive)” may be interchanged and may be interpreted as receiving from other subjects, getting from a protocol, getting by self-processing, achieving by self-implementation, and other meanings.

In some embodiments, the terms “send,” “report,” “issue,” and “transmit (send and/or receive)” may be interchanged.

In some embodiments, the obtainment of data, information, and the like may comply with laws and regulations of the country where it is located.

In some embodiments, data, information, and the like may be obtained after consent of a user is obtained.

In some embodiments, the terms such as terminal, terminal device, user equipment (UE), user terminal, mobile station (MS), mobile terminal (MT), subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, and client may be interchanged.

In the embodiments of the present disclosure, although operations are described in a specific order in the accompanying drawings, it is not to be understood that these operations need to be performed in the specific order or in a serial order, or that all the shown operations need to be performed to obtain a desired result. In a specific environment, multitasking and parallel processing may be favorable. In addition, it is also beneficial to send a plurality of pieces of information via the same message.

The following describes an application environment of the technical solutions provided in the embodiments of the present disclosure.

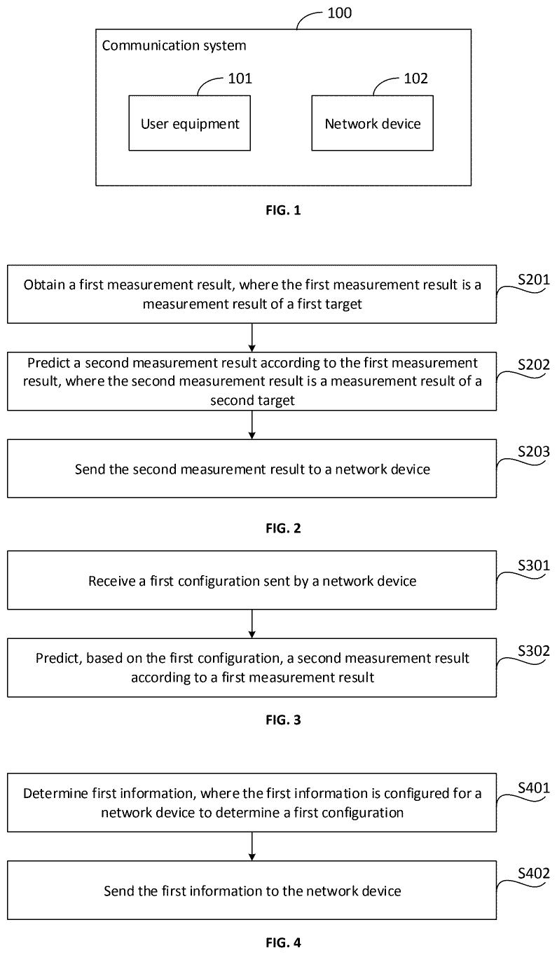

FIG. 1 is a schematic diagram of a communication system according to some embodiments. As shown in FIG. 1, the communication system 100 includes user equipment 101 and a network device 102. It is to be noted that the quantity of the user equipment 101 and the network device 102 shown in FIG. 1 is merely an example and does not constitute any limitation on the embodiments of the present disclosure. In an actual case, there may be one or more user equipment 101, and one or more network devices 102.

In some embodiments, the communication system 100 is, for example, a long-term evolution (LTE) system, a 5th generation (5G) mobile communication system, a 5G new radio (NR) system, or other future communication systems, but is not limited to these.

In some embodiments, the user equipment 101 may include at least one of a mobile phone, a wearable device, an internet of things device, a vehicle with a communication function, a smart vehicle, a Pad, a computer with a wireless transceiving function, a virtual reality (VR) terminal device, an augmented reality (AR) terminal device, a wireless terminal device in industrial control, a wireless terminal device in self-driving, a wireless terminal device in a remote medical surgery, a wireless terminal device in smart grid, a wireless terminal device in transportation safety, a wireless terminal device in a smart city, or a wireless terminal device in a smart home, but is not limited to these.

In some embodiments, the network device 102 may include at least one of an access network device or a core network device.

In some embodiments, the network device 102 may include an evolved NodeB (eNB), a next generation NodeB (gNB) in a new radio (NR) system, and a base station in other future communication systems, but is not limited to these.

In the communication system 100, the network device 102 sends a measurement configuration to the user equipment 101, and the user equipment 101 performs a measurement according to the measurement configuration. The measurement configuration includes a measurement object, a report config, and a quantity config.

The measurement object indicates a frequency that needs to be measured, and may include a plurality of access technologies, including NR and LTE. Each measurement object is bound to one measurement object index identifier (measObject ID). The report config indicates a type of reporting by the user equipment, including periodic reporting or event-based reporting. Different report configs may be configured for measurement objects of different access technologies, and each report config is bound to one report config index identifier (reportconfig ID).

In one example, the event-based report config may provide one or more of the following configurations:
a type of signal that triggers reporting, including reference signal receiving power (RSRP), reference signal receiving quality (RSRQ), or a signal to interference plus noise ratio (SINR);
a threshold or bias; and
a type of reported measurement result, including the RSRP, the RSRQ, or the SINR.

In some embodiments, the user equipment compares a relationship between measurement results of serving cells or neighbor cells, or a relationship between the measurement result and a threshold. Measurement reporting is triggered in a case where the threshold requirement is met. In one example, measurement reporting includes event-based reporting and periodic reporting.

In one example, the event-based reporting includes events A1 to A6, events B1 and B2, an event D1, and an event T1. The A series of events is configured for intra-system mobility management, the B series of events is configured for inter-system mobility management, and the event D1 and the event T1 are configured for satellite system mobility management.

For example, the A series of events is as follows:
Event A1: The serving cell becomes better than the threshold.
Event A2: The serving cell becomes worse than the threshold.
Event A3: The neighbor cell becomes better than an offset of the primary cell (Pcell)/primary secondary Cell (PSCell).
Event A4: The neighbour cell becomes better than the threshold.
Event A5: The PCell/PSCell becomes worse than a threshold 1, and the neighbor cell becomes better than a threshold 2.
Event A6: The neighbour cell becomes better than an offset of a secondary cell (Scell).

An entering condition and a leaving condition are defined for each event. The user equipment evaluates the entering condition of this event, in a case where the entering condition is not met. The user equipment evaluates the leaving condition of this even for an event where the entering condition is met. Measurement reporting may be triggered, in a case where the entering condition or the leaving condition of this event is met.

The following is an example explanation using the event A3.

For the event A3, an inequality A3-1 (the entering condition) is Mn+Ofn+Ocn−Hys>Mp+Ofp+Ocp+Off, and an inequality A3-2 (the leaving condition) is Mn+Ofn+Ocn+Hys<Mp+Ofp+Ocp+Off. Mn may be a measurement result of the neighbor cell, without considering any offset. Ofn may be a measurement object-specific offset of a reference signal of the neighbor cell (such as offsetMO defined in measObjectNR corresponding to the neighbor cell). Ocn may be a specific offset of the neighbor cell (such as cellIndividualOffset defined in measObjectNR corresponding to a frequency of the neighbor cell), and is set to zero, in a case where the specific offset is not configured for the neighbor cell. Mp may be a measurement result of SpCell, without considering any offset. Ofp may be a measurement object-specific offset of the SpCell (namely, offsetMO defined in measObjectNR corresponding to the SpCell). Ocp is a cell-specific offset of the SpCell (namely, cellIndividualOffset defined in the measObjectNR corresponding to the SpCell), and is set to zero in a case where the specific offset is not configured for the SpCell. Hys may be a hysteresis parameter for the event (such as a hysteresis defined for the event in reportConfigNR of the event). Off may be an offset parameter for the event (such as a3-Offset defined in the reportConfigNR of the event). The units of Mn and Mp are expressed in dBm for the RSRP and in dB for the RSRQ and the RS-SINR. The units of Ofn, Ocn, Ofp, Ocp, Hys, and Off can be expressed in dB.

After measurement reporting is triggered, the user equipment sends to the network device an identifier and a measurement result of a cell that triggers a reporting event, and/or identifiers and measurement results of N cells with the best measurement results.

A user equipment measures a cell. During the measurement process, the user equipment needs to obtain a measurement result of a target cell by receiving a reference signal sent by the target cell. However, receiving the reference signal sent by the target cell consumes the power of the user equipment.

FIG. 2 is a flowchart of a method for reporting a measurement according to some embodiments. Referring to FIG. 2, the method for reporting a measurement is applied to user equipment and includes the following steps S201 to S203.

In step S201, a first measurement result is obtained, where the first measurement result is a measurement result of a first target.

In some embodiments, the first measurement result is a measurement result obtained by measuring the first target by the user equipment.

In step S202, a second measurement result is predicted according to the first measurement result, where the second measurement result is a measurement result of a second target.

In step S203, the second measurement result is sent to a network device.

In some embodiments, the first target and the second target may be cells or beams of a cell.

In some embodiments, the first measurement result and the second measurement result may be RSRP values, RSRQ values, or SINR values of the cell or the beam.

In some embodiments, the user equipment may obtain a measurement result of a first cell by measuring the first cell and predict a measurement result of a second cell according to the measurement result of the first cell to obtain the second measurement result. This means that the user equipment does not need to measure the second cell.

In some embodiments, the user equipment may obtain a measurement result of a first beam by measuring the first beam and predict a measurement result of a second beam according to the measurement result of the first beam to obtain the second measurement result. This means that the user equipment does not need to measure the second beam.

According to the above technical solution, the user equipment may obtain the second measurement result by predicting the measurement result of the second target according to the measurement result of the first target, and perform measurement reporting according to the second measurement result. Hence, there is no need to receive a reference signal of the second target and measure the second target, which reduces the number of measurements and the power needed for measurement by the user equipment.

It may be understood that the user equipment can perform measurement reporting based on event triggering or periodic triggering.

In some embodiments, the first target and the second target may be different cells on a same frequency; or the first target and the second target may be different cells on different frequencies. The first target and the second target may be on different frequencies.

In some embodiments, the first target and the second target may be different beams of a same cell; or the first target and the second target may be different beams of different cells. The first target and the second target may be in different cells. The first target and the second target may be on different frequencies.

In some embodiments, the first target and the second target may be indicated by a measurement object. The network device may send a measurement configuration to the user equipment. The measurement configuration includes a measurement object. The measurement object indicates a frequency and/or a cell that needs to be measured (a measurement target cell). The measurement object may include a first measurement object, and may further include a second measurement object. The first measurement object indicates measuring a first cell at a first to-be-measured frequency. The second measurement object indicates to measure a second cell on a second to-be-measured frequency.

In some other embodiments, the first target may be indicated by the measurement object, and the second target may not be indicated by the measurement object.

In some embodiments, the second measurement result may be predicted via an artificial intelligence (AI) model according to the first measurement result. In the present disclosure, the AI model may be obtained via a large amount of training data, and the second measurement result may be accurately predicted via the AI model by using the first measurement result as an input.

In some embodiments, based on a first configuration, the second measurement result is predicted according to the first measurement result. The first configuration may be sent by the network device to the user equipment.

FIG. 3 is a flowchart of a method for reporting a measurement according to some embodiments. Referring to FIG. 3, the method for reporting a measurement is applied to user equipment and includes the following steps S301 and S302.

In step S301, a first configuration sent by a network device is received.

In step S302, a second measurement result is predicted according to a first measurement result based on the first configuration.

In some embodiments, the first configuration may include at least one of:
allowing the user equipment to predict the second measurement result according to the first measurement result, or not allowing the user equipment to predict the second measurement result according to the first measurement result;
a correspondence between a first target and a second target;
a type of the first measurement result; or
a type of the second measurement result.

For example, the user equipment may predict, based on the first configuration, the second measurement result of the cell A according to the first measurement result of the cell E, assuming that the correspondence between the first target and the second target includes “cell E-cell A”.

The type of the first measurement result may be RSRP, RSRQ, or an SINR.

The type of the second measurement result may be RSRP, RSRQ, or an SINR.

According to the above technical solution, the user equipment may predict, based on the first configuration sent by the network device, the second measurement result according to the first measurement result.

In some embodiments, based on the first configuration, the second measurement result may be predicted via an AI model according to the first measurement result.

FIG. 4 is a flowchart of a method for reporting a measurement according to some embodiments. Referring to FIG. 4, the method for reporting a measurement is applied to user equipment and includes the following steps S401 and S402.

In step S401, first information is determined, where the first information is configured for a network device to determine a first configuration.

In step S402, the first information is sent to the network device.

According to the above technical solution, the user equipment may help the network device determine the first configuration by sending the first information to the network device. Naturally, the network device may also directly determine the first configuration without the first information.

In some embodiments, the first information includes at least one of:
a cell or a beam for which the user equipment supports prediction; or
a type of a measurement result for which the user equipment supports prediction.

The type of the measurement result for which the user equipment supports prediction may be RSRP, RSRQ, or an SINR.

In some embodiments, the user equipment may determine the first information according to a measurement configuration sent by the network device.

For example, the network device sends the measurement configuration to the user equipment. The user equipment determines, according to the measurement configuration, the cell or the beam supported for prediction. For example, at least one of the following is performed: the user equipment determines predictable cells A, B, and C according to its own capability; or the user equipment determines, according to the measurement configuration, the type of the measurement result supported for prediction, such as the type of the measurement result supported for prediction being the RSRP. Hence, the first information is determined and sent to the network device. The network device determines the first configuration according to the first information and then sends the first configuration to the user equipment.

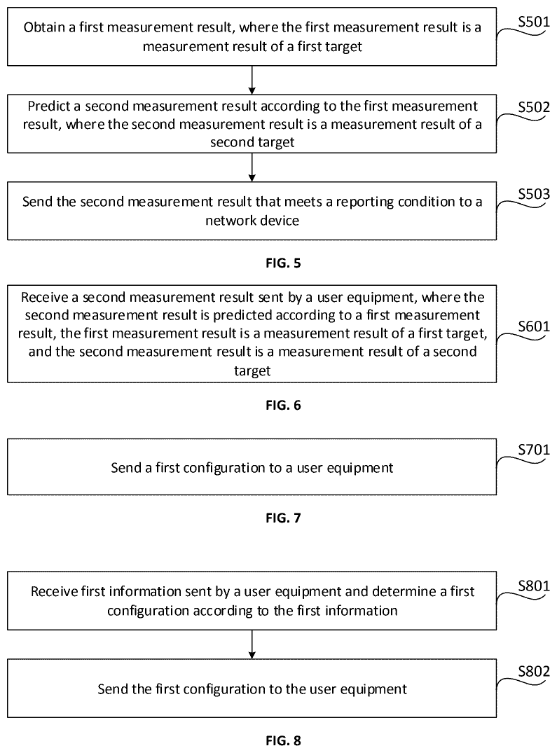

FIG. 5 is a flowchart of a method for reporting a measurement according to some embodiments. Referring to FIG. 5, the method for reporting a measurement is applied to user equipment and includes the following steps S501 to S503.

In step S501, a first measurement result is obtained, where the first measurement result is a measurement result of a first target.

In step S502, a second measurement result is predicted according to the first measurement result, where the second measurement result is a measurement result of a second target.

In step S503, the second measurement result that meets a reporting condition is sent to a network device.

In some embodiments, the user equipment may trigger, according to a measurement configuration, measurement reporting based on an event or periodically. The user equipment sends the second measurement result that meets the reporting condition to the network device, when performing measurement reporting.

In some embodiments, the reporting condition includes at least one of:
an entering condition or a leaving condition based on an event;
the second target is a cell, and the second measurement result is a cell measurement result that meets a first preset condition on a frequency where the second target is located;
the second target is a beam, and the second measurement result is a beam measurement result that meets a second preset condition in a cell where the second target is located;
the second target is a measurement target cell;
the second target is a beam of the measurement target cell; or
the second target is a measurement target beam.

In some embodiments, the first preset condition may indicate that the second measurement result is the best measurement result among measurement results of a plurality of cells on the frequency where the second target is located, or may indicate that the second measurement results are top-N measurement results among measurement results of a plurality of cells on the frequency where the second target is located.

In some embodiments, the second preset condition may indicate that the second measurement result is the best measurement result among measurement results of a plurality of beams in the cell where the second target is located, or may indicate that the second measurement results are top-M measurement results among measurement results of a plurality of beams in the cell where the second target is located.

The measurement target cell is a cell to be measured that is indicated by the network device in the measurement configuration.

The measurement target beam is a beam to be measured that is indicated by the network device in the measurement configuration.

In some embodiments, the measurement configuration includes a report config, and the report config is configured to indicate a type of reporting by the user equipment, including event-based reporting or periodic reporting.

Event-based measurement reporting is used as an example.

In some embodiments, the user equipment evaluates an event based on the second measurement result. Measurement reporting may be triggered, in a case where the entering condition of the event is met. The user equipment sends the second measurement result that meets the entering condition of the event to the network device, when performing measurement reporting.

In some embodiments, the user equipment evaluates an event based on the second measurement result. Measurement reporting may be triggered, in a case where the leaving condition of the event is met. The user equipment sends the second measurement result that meets the leaving condition of the event to the network device, when performing measurement reporting.

In some embodiments, in addition to sending the second measurement result that meets the entering condition or the leaving condition of the event to the network device, the user equipment may further send the best cell measurement result, namely, the second measurement result that meets the first present condition, among the measurement results of the plurality of cells on the frequency where the second target is located, when performing measurement reporting.

In some embodiments, in addition to sending the second measurement result that meets the entering condition or the leaving condition of the event to the network device, the user equipment may further send the best beam measurement result, namely, the second measurement result that meets the second preset condition, among the measurement results of the plurality of beams of the cell where the second target is located, when performing measurement reporting.

Periodic reporting is used as an example.

In some embodiments, the user equipment periodically triggers measurement reporting. When performing measurement reporting, the user equipment may send, to the network device, at least one of the following measurement results:
the best cell measurement result, namely, the second measurement result that meets the first preset condition, among the measurement results of the plurality of cells on the frequency where the second target is located;
the best beam measurement result, namely, the second measurement result that meets the second preset condition, among the measurement results of the plurality of beams of the cell where the second target is located;
the second measurement result of the measurement target cell;
the second measurement result of the beam of the measurement target cell; or
the second measurement result of the measurement target beam.

According to the above technical solution, the user equipment may send, to the network device, the second measurement result that meets the reporting condition to the network device based on an event or periodically.

In some embodiments, when performing measurement reporting, in addition to sending the second measurement result, the user equipment may send, to the network device, at least one of:
a cell identifier or a beam identifier corresponding to the second measurement result;
second information, configured to indicate that the second measurement result is a prediction result;
the first measurement result; or
a confidence value of the second measurement result.

In some embodiments, the user equipment may send, to the network device, the second measurement result and the cell identifier or the beam identifier corresponding to the second measurement result.

In some embodiments, the user equipment may send, to the network device, the second measurement result and the second information configured to indicate that the second measurement result is the prediction result.

In some embodiments, the user equipment may send, to the network device, the second measurement result and the first measurement result configured to predict the second measurement result. For example, the network device may verify the second measurement result according to the first measurement result.

In some embodiments, the user equipment may send, to the network device, the second measurement result and the confidence value of the second measurement result. For example, the network device may determine, according to the confidence value of the second measurement result, whether to trust the second measurement result.

FIG. 6 is a flowchart of a method for reporting a measurement according to some embodiments. Referring to FIG. 6, the method for reporting a measurement is applied to a network device and includes the following step S601.

In step S601, a second measurement result sent by a user equipment is received, where the second measurement result is predicted according to a first measurement result, the first measurement result is a measurement result of a first target, and the second measurement result is a measurement result of a second target.

In some embodiments, the first measurement result is a measurement result obtained by measuring the first target by the user equipment.

In some embodiments, the first target and the second target may be cells or beams of a cell.

In some embodiments, the first measurement result and the second measurement result may be RSRP values, RSRQ values, or SINR values of the cell or the beam.

According to the above technical solution, the user equipment may obtain the second measurement result by predicting the measurement result of the second target according to the measurement result of the first target, and the network device receives the second measurement result sent by the user equipment. Hence, the user equipment does not need to receive a reference signal of the second target or measure the second target, which reduces the number of measurements and the power needed for measurement by the user equipment.

In some embodiments, the first target and the second target may be different cells on a same frequency; or the first target and the second target may be different cells on different frequencies. The first target and the second target may be on different frequencies.

In some embodiments, the first target and the second target may be different beams of a same cell; or the first target and the second target may be different beams of different cells. The first target and the second target may be in different cells. The first target and the second target may be on different frequencies.

FIG. 7 is a flowchart of a method for reporting a measurement according to some embodiments. Referring to FIG. 7, the method for reporting a measurement is applied to a network device and includes the following step S701.

In step S701, a first configuration is sent to a user equipment.

The user equipment may predict, based on the first configuration, a second measurement result according to a first measurement result.

In some embodiments, the first configuration may include at least one of:
allowing the user equipment to predict the second measurement result according to the first measurement result, or not allowing the user equipment to predict the second measurement result according to the first measurement result;
a correspondence between a first target and a second target;
a type of the first measurement result; or
a type of the second measurement result.

The type of the first measurement result may be RSRP, RSRQ, or an SINR.

The type of the second measurement result may be RSRP, RSRQ, or an SINR.

According to the above technical solution, the network device may send the first configuration to the user equipment, facilitating the user equipment in predicting, based on the first configuration, the second measurement result according to the first measurement result.

FIG. 8 is a flowchart of a method for reporting a measurement according to some embodiments. Referring to FIG. 8, the method for reporting a measurement is applied to a network device and includes the following steps S801 and S802.

In step S801, first information sent by a user equipment is received, and a first configuration is determined according to the first information.

In step S802, the first configuration is sent to the user equipment.

According to the above technical solution, the network device may determine the first configuration according to the first information sent by the user equipment, and send the first configuration to the user equipment. Naturally, the network device may also directly determine the first configuration without the first information.

In some embodiments, the first information includes at least one of:
a cell or a beam for which the user equipment supports prediction; or
a type of a measurement result for which the user equipment supports prediction.

In some embodiments, the user equipment may determine the first information according to a measurement configuration sent by the network device.

For example, the network device sends the measurement configuration to the user equipment. The user equipment determines, according to the measurement configuration, the cell or the beam supported for prediction. For example, at least one of the following is performed: the user equipment determines predictable cells A, B, and C according to its own capability, or, the user equipment determines, according to the measurement configuration, the type of the measurement result supported for prediction, such as the type of the measurement result supported for prediction being the RSRP. Hence, the first information is determined and sent to the network device. The network device determines the first configuration according to the first information and then sends the first configuration to the user equipment.

In some embodiments, the user equipment may trigger, according to the measurement configuration, measurement reporting based on an event or periodically. The user equipment may send a second measurement result that meets a reporting condition to the network device, when performing measurement reporting.

Hence, step S601 includes: the second measurement result that meets the reporting condition sent by the user equipment is received.

In some embodiments, the reporting condition includes at least one of:
an entering condition or a leaving condition based on an event;
a second target is a cell, and the second measurement result is a cell measurement result that meets a first preset condition on a frequency where the second target is located;
the second target is a beam, and the second measurement result is a beam measurement result that meets a second preset condition in a cell where the second target is located;
the second target is a measurement target cell;
the second target is a beam of the measurement target cell; or
the second target is a measurement target beam.

Since the embodiment of the user equipment sending the second measurement result that meets the reporting condition has been described previously, it will not be redundantly elaborated in the method embodiment of the network device.

In some embodiments, in addition to receiving the second measurement result sent by the user equipment, the network device may also receive at least one of:
a cell identifier or a beam identifier corresponding to the second measurement result;
second information, configured to indicate that the second measurement result is a prediction result;
a first measurement result; or
a confidence value of the second measurement result.

In some embodiments, the network device receives the second measurement result and the cell identifier or the beam identifier corresponding to the second measurement result sent by the user equipment.

In some embodiments, the network device receives the second measurement result and the second information configured to indicate that the second measurement result is the prediction result sent by the user equipment.

In some embodiments, the network device receives the second measurement result and the first measurement result configured to predict the second measurement result sent by the user equipment.

In some embodiments, the network device may verify the second measurement result according to the first measurement result. For example, in a case where it is verified that the second measurement result predicted according to the first measurement result is incorrect, corresponding adjustment may be made, such as indicating the user equipment to replace the first measurement result configured to predict the second measurement result, and re-predict the second measurement result.

In some embodiments, the network device receives the second measurement result and the confidence value of the second measurement result sent by the user equipment. Optionally, an AI model may output a corresponding confidence value when outputting the second measurement result.

In some embodiments, the network device may determine, according to the confidence value of the second measurement result, whether to trust the second measurement result. Optionally, the network device may perform mobility management on the user equipment according to whether to trust the second measurement result.

For example, the network device receives the second measurement result reported by the user equipment, and the second measurement result is the best measurement result among measurement results of a plurality of cells on a certain frequency. In a case where it is determined, according to the confidence value, that the second measurement result is trusted, the network device may switch the user equipment to the cell with the measurement result. Cell switching may not be performed, in a case where it is determined, according to the confidence value, that the second measurement result is not trusted.

FIG. 9 is a flowchart of a method for reporting a measurement according to some embodiments. Referring to FIG. 9, the method for reporting a measurement includes the following steps S901 to S906.

In step S901, a user equipment 101 determines first information.

It is to be noted that this step is optional in some examples.

In some embodiments, the user equipment may determine the first information according to a measurement configuration sent by a network device.

In some embodiments, the first information includes at least one of:
a cell or a beam for which the user equipment supports prediction; or
a type of a measurement result for which the user equipment supports prediction.

The type of the measurement result for which the user equipment supports prediction may be RSRP, RSRQ, or an SINR.

In step S902, the user equipment 101 sends the first information to the network device 102, where the first information is configured for the network device to determine a first configuration.

It is to be noted that this step is optional in some examples.

In step S903, the network device 102 determines the first configuration according to the first information.

It is to be noted that this step is optional in some examples. The network device may directly determine the first configuration without the first information.

In step S904, the network device 102 sends the first configuration to the user equipment 101.

In some embodiments, the first configuration may include at least one of:
allowing the user equipment to predict a second measurement result according to a first measurement result, or not allowing the user equipment to predict a second measurement result according to the first measurement result;
a correspondence between a first target and a second target;
a type of the first measurement result; or
a type of the second measurement result.

In step S905, the user equipment 101 obtains the first prediction result and predicts, based on the first configuration, the second measurement result according to the first measurement result.

In step S906, the user equipment 101 sends the second measurement result that meets a reporting condition to the network device 102.

In some embodiments, the user equipment may trigger, according to a measurement configuration, measurement reporting based on an event or periodically. The user equipment sends the second measurement result that meets the reporting condition to the network device, when performing measurement reporting.

According to the above technical solution, the network device determines the first configuration according to the first information sent by the user equipment, and issues the first configuration to the user equipment, and the user equipment obtains the second measurement result by predicting, based on the first configuration, the second measurement result of the second target according to the first measurement result of the first target, and performs measurement reporting according to the second measurement result. Hence, the user equipment does not need to receive a reference signal of the second target or measure the second target, which reduces the number of measurements and the power needed for measurement by the user equipment.

In some embodiments, the reporting condition includes at least one of:
an entering condition or a leaving condition based on an event;
the second target is a cell, and the second measurement result is a cell measurement result that meets a first preset condition on a frequency where the second target is located;
the second target is a beam, and the second measurement result is a beam measurement result that meets a second preset condition in a cell where the second target is located;
the second target is a measurement target cell;
the second target is a beam of the measurement target cell; or
the second target is a measurement target beam.

In some embodiments, when performing measurement reporting, in addition to sending the second measurement result to the network device, the user equipment may send at least one of:
a cell identifier or a beam identifier corresponding to the second measurement result;
second information, configured to indicate that the second measurement result is a prediction result;
a first measurement result; or
a confidence value of the second measurement result.

It is to be noted that for other content in the flowchart shown in FIG. 9, refer to the descriptions of the related content in the foregoing embodiments, and details will not be redundantly elaborated here.

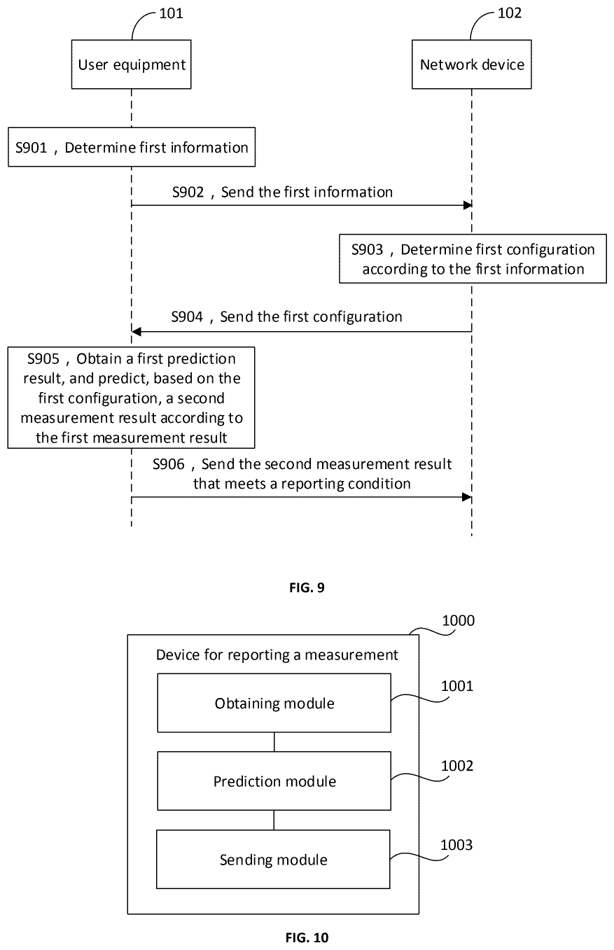

FIG. 10 is a block diagram of a device for reporting a measurement according to some embodiments. Referring to FIG. 10, the device for reporting a measurement 1000 is applied to the user equipment. The device for reporting a measurement 1000 may include:
an obtaining module 1001 configured to obtain a first measurement result, where the first measurement result is a measurement result of a first target;
a prediction module 1002 configured to predict a second measurement result according to the first measurement result, where the second measurement result is a measurement result of a second target; and
a sending module 1003 configured to send the second measurement result to a network device.

In some embodiments, the prediction module 1002 is configured to predict, via an AI model, the second measurement result according to the first measurement result.

In some embodiments, the first target and the second target are different cells on a same frequency; or
the first target and the second target are different cells on different frequencies; or
the first target and the second target are different beams of a same cell; or
the first target and the second target are different beams of different cells.

In some embodiments, the prediction module 1002 is configured to predict, based on a first configuration, the second measurement result according to the first measurement result.

In some embodiments, the first configuration includes at least one of:
allowing the user equipment to predict the second measurement result according to the first measurement result, or not allowing the user equipment to predict the second measurement result according to the first measurement result;
a correspondence between the first target and the second target;
a type of the first measurement result; or
a type of the second measurement result.

In some embodiments, the method for reporting a measurement 1000 further includes a receiving module configured to receive the first configuration sent by the network device.

In some embodiments, the sending module 1003 is configured to send first information to the network device.

In some embodiments, the device for reporting a measurement 1000 further includes a determination module configured to determine the first information.

In some embodiments, the first information includes at least one of:
a cell or a beam for which the user equipment supports prediction; or
a type of a measurement result for which the user equipment supports prediction.

In some embodiments, the sending module 1003 is configured to send the second measurement result that meets a reporting condition to the network device.

In some embodiments, the reporting condition includes at least one of:
an entering condition or a leaving condition based on an event;
the second target is a cell, and the second measurement result is a cell measurement result that meets a first preset condition on a frequency where the second target is located;
the second target is a beam, and the second measurement result is a beam measurement result that meets a second preset condition in a cell where the second target is located;
the second target is a measurement target cell;
the second target is a beam of the measurement target cell; or
the second target is a measurement target beam.

In some embodiments, the sending module 1003 is configured to send, to the network device, a cell identifier or a beam identifier corresponding to the second measurement result.

In some embodiments, the sending module 1003 is configured to send second information to the network device, where the second information is configured to indicate that the second measurement result is a prediction result.

In some embodiments, the sending module 1003 is configured to send the first measurement result to the network device.

In some embodiments, the sending module 1003 is configured to send a confidence value of the second measurement result to the network device.

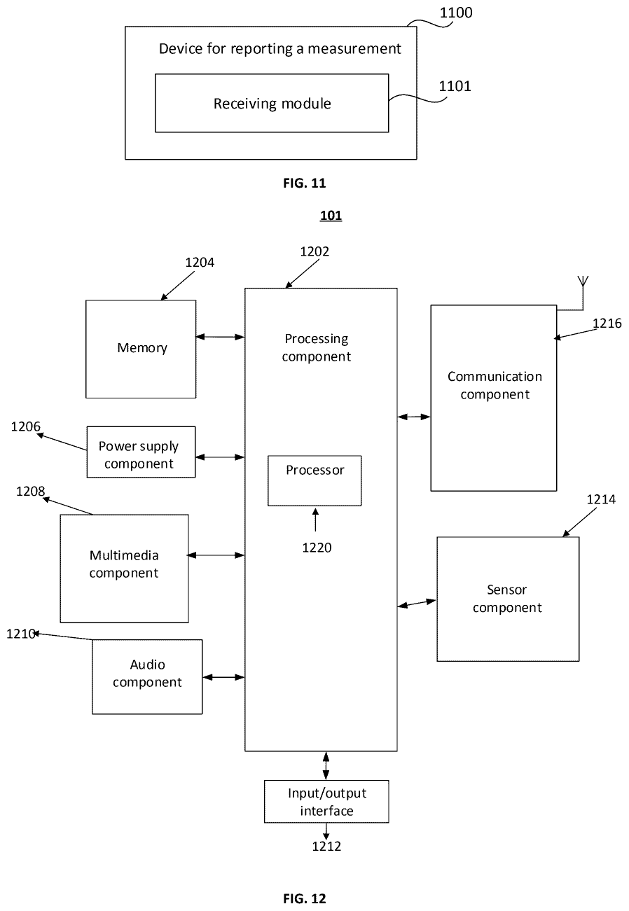

FIG. 11 is a block diagram of a device for reporting a measurement according to some embodiments. Referring to FIG. 11, the device for reporting a measurement 1100 is applied to a network device. The device for reporting a measurement 1100 may include:
a receiving module 1101 configured to receive a second measurement result sent by a user equipment, where the second measurement result is predicted according to a first measurement result, the first measurement result is a measurement result of a first target, and the second measurement result is a measurement result of a second target.

In some embodiments, the first target and the second target are different cells on a same frequency; or
the first target and the second target are different cells on different frequencies; or
the first target and the second target are different beams of a same cell; or
the first target and the second target are different beams of different cells.

In some embodiments, the device for reporting a measurement 1100 further includes a sending module configured to send a first configuration to the user equipment, where the first configuration is configured for the user equipment to predict, based on the first configuration, the second measurement result according to the first measurement result.

In some embodiments, the first configuration includes at least one of:
allowing the user equipment to predict the second measurement result according to the first measurement result, or not allowing the user equipment to predict the second measurement result according to the first measurement result;
a correspondence between the first target and the second target;
a type of the first measurement result; or
a type of the second measurement result.

In some embodiments, the receiving module 1101 is configured to receive first information sent by the user equipment. The device for reporting a measurement 1100 further includes a determination module configured to determine the first configuration according to the first information.

In some embodiments, the first information includes at least one of:
a cell or a beam for which the user equipment supports prediction; or
a type of a measurement result for which the user equipment supports prediction.

In some embodiments, the receiving module 1101 is configured to receive the second measurement result that meets a reporting condition sent by the user equipment.

In some embodiments, the reporting condition includes at least one of:
an entering condition or a leaving condition based on an event;
the second target is a cell, and the second measurement result is a cell measurement result that meets a first preset condition on a frequency where the second target is located;
the second target is a beam, and the second measurement result is a beam measurement result that meets a second preset condition in a cell where the second target is located;
the second target is a measurement target cell;
the second target is a beam of the measurement target cell; or
the second target is a measurement target beam.

In some embodiments, the receiving module 1101 is configured to receive a cell identifier or a beam identifier corresponding to the second measurement result that is sent by the user equipment.

In some embodiments, the receiving module 1101 is configured to receive second information sent by the user equipment, where the second information is configured to indicate that the second measurement result is a prediction result.

In some embodiments, the receiving module 1101 is configured to receive the first measurement result sent by the user equipment.

In some embodiments, the receiving module 1101 is configured to receive a confidence value of the second measurement result that is sent by the user equipment.

Regarding the device for reporting a measurement in the above embodiment, specific manners in which each module performs operations have been described in detail in the related method embodiments, and details will not be redundantly elaborated here.

The present disclosure further provides a computer-readable storage medium. The computer-readable storage medium stores computer program instructions, where the program instructions, when executed by a processor, implement the method for reporting a measurement provided in the present disclosure.

FIG. 12 is a block diagram of a user equipment according to some embodiments. For example, the user equipment 101 may be a mobile phone, a computer, a digital broadcast terminal, a messaging device, a game console, a tablet device, a medical device, a fitness device, a personal digital assistant, a smart vehicle, etc. It is to be noted that the user equipment 101 may perform the method for reporting a measurement of the present disclosure.

Referring to FIG. 12, the user equipment 101 may include one or more of the following components: a processing component 1202, a memory 1204, a power supply component 1206, a multimedia component 1208, an audio component 1210, an input/output interface 1212, a sensor component 1214, and a communication component 1216.

The processing component 1202 generally controls the overall operation of the user equipment 101, such as operations associated with display, telephone calls, data communication, camera operations, and recording operations. The processing component 1202 may include one or more processors 1220 to execute instructions to complete all or some of the steps of the above method for reporting a measurement applied to the user equipment. In addition, the processing component 1202 may include one or more modules to facilitate interaction between the processing component 1202 and other components. For example, the processing component 1202 may include a multimedia module to facilitate interaction between the multimedia component 1208 and the processing component 1202.

The memory 1204 is configured to store various types of data to support the operation of the user equipment 101. Examples of the data include instructions for any applications or methods operating on the user equipment 101, contact data, phone book data, messages, pictures, videos, etc. The memory 1204 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power supply component 1206 supplies power to various components of the user equipment 101. The power supply component 1206 may include a power management system, one or more power supplies, and other components associated with generating, managing, and distributing power for the user equipment 101.

The multimedia component 1208 includes a screen that provides an output interface between the user equipment 101 and a user. In some embodiments, the screen may include a liquid crystal display (LCD) and a touch panel (TP). The screen, in a case of including a touch panel, may be implemented as a touch screen to receive an input signal from the user. The touch panel includes one or more touch sensors to sense touches, slides, and gestures on the touch panel. The touch sensor may not only sense a boundary of a touch action or a slide action, but also detect a duration and pressure associated with the touch or slide operation. In some embodiments, the multimedia component 1208 may include at least one of a front camera or a rear camera. The at least one of front camera or the rear camera may receive external multimedia data, in a case where the user equipment 101 is in an operating mode, such as a shooting mode or a video mode. Each of the front cameras or rear cameras may be a fixed optical lens system, or may have a focal length and optical zoom capability.

The audio component 1210 is configured to output and/or input an audio signal. For example, the audio component 1210 includes one microphone (MIC). The microphone is configured to receive an external audio signal in a case where the user equipment 101 is in the operating mode, such as a call mode, a recording mode, or a voice recognition mode. The received audio signal may be further stored in the memory 1204 or sent via the communication component 1216. In some embodiments, the audio component 1210 further includes one speaker configured to output the audio signal.

The input/output interface 1212 provides an interface between the processing component 1202 and a peripheral interface module. The above peripheral interface module may be a keyboard, a click wheel, buttons, etc. These buttons may include, but are not limited to, a home button, volume buttons, a start button, and a lock button.

The sensor component 1214 includes one or more sensors to provide state assessments for the user equipment 101 in various aspects. For example, the sensor component 1214 may detect an on/off state of the user equipment 101 and a relative positioning of a component. For example, the component is the display and keypad of the user equipment 101. The sensor component 1214 may further detect a change in the position of the user equipment 101 or one component of the user equipment 101, the presence or absence of a contact between the user and the user equipment 101, the orientation or acceleration/deceleration of the user equipment 101, and a temperature change of the user equipment 101. The sensor component 1214 may include a proximity sensor configured to detect the presence of a nearby object without any physical contact. The sensor component 1214 may further include a light sensor, such as a CMOS or CCD image sensor, for use in imaging applications. In some embodiments, the sensor component 1214 may further include an acceleration sensor, a gyroscope sensor, a magnetic sensor, a pressure sensor, or a temperature sensor.

The communication component 1216 is configured to facilitate communication between the user equipment 101 and other devices in a wired or wireless manner. The user equipment 101 may access a wireless network based on a communication standard, such as Wi-Fi, 2G, 3G, 4G, 5G, 6G, or a combination of them. In one example, the communication component 1216 receives a broadcast signal or broadcast-related information from an external broadcast management system via a broadcast channel. In one example, the communication component 1216 further includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In examples, the user equipment 101 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components to perform the method for reporting a measurement of the present disclosure.

In examples, a non-transitory computer-readable storage medium including instructions is further provided, such as the memory 1204 including instructions. The instructions may be executed by the processor 1220 of the user equipment 101 to implement the method for reporting a measurement of the present disclosure. For example, the non-transitory computer-readable storage medium may be a ROM, a random access memory (RAM), a CD-ROM, a magnetic tape, a floppy disk, or an optical data storage device.

In another example, a computer program product is further provided. The computer program product includes a computer program executable by a programmable device, where the computer program has a code part, when executed by the programmable device, implements the method for reporting a measurement of the present disclosure.

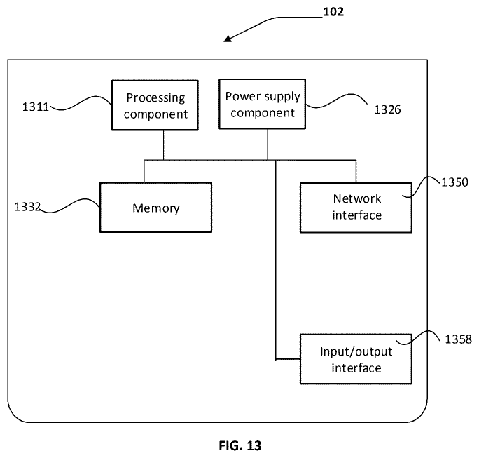

FIG. 13 is a block diagram of a network device according to an example. It is to be noted that the network device 102 may perform the method for reporting a measurement of the present disclosure.

Referring to FIG. 13, the network device 102 includes a processing component 1311, which further includes one or more processors, and a memory resource represented by a memory 1332 for storing instructions that can be executed by the processing component 1311, such as an application. The application stored in the memory 1332 may include one or more modules, and each module corresponds to a set of instructions. In addition, the processing component 1311 is configured to execute the instructions to implement the method for reporting a measurement applied to the network device that is provided in the above method embodiments.

The network device 102 may further include a power supply component 1326 configured to execute power management of the network device 102, a wired or wireless network interface 1350 configured to connect the network device 102 to a network, and an input/output interface 1358. The network device 102 may operate based on an operating system stored in the memory 1332.

As used herein, the term processor may refer to one processor that performs the defined functions or a plurality of processors that collectively perform defined functions, such that the execution of the individual defined functions may be divided amongst such processors.

Those skilled in the art will easily think of other implementations of the present disclosure after considering the specification and practicing the present disclosure. The present disclosure is intended to cover any variations, uses, or adaptations of the present disclosure. These variations, uses, or adaptations follow the general principles of the present disclosure and include common knowledge or conventional techniques in the technical field that are not disclosed in the present disclosure. The specification and the embodiments are merely considered as illustrative, and the true scope and spirit of the present disclosure are indicated by the following claims.

It is to be understood that the present disclosure is not limited to the precise structures that have been described and illustrated in the accompanying drawings, and various modifications and changes may be made without departing from the scope of the present disclosure. The scope of the present disclosure is limited merely by the appended claims.

1. A method for reporting a measurement, performed by a user equipment, the method comprising:
obtaining a first measurement result, wherein the first measurement result is a measurement result of a first target;
predicting a second measurement result according to the first measurement result, wherein the second measurement result is a measurement result of a second target; and
sending the second measurement result to a network device.

2. The method according to claim 1, wherein predicting the second measurement result according to the first measurement result comprises:
predicting, via an artificial intelligence (AI) model, the second measurement result according to the first measurement result.

3. The method according to claim 1, wherein
the first target and the second target are different cells on a same frequency;
the first target and the second target are different cells on different frequencies;
the first target and the second target are different beams of a same cell; or
the first target and the second target are different beams of different cells.

4. The method according to claim 1, wherein predicting the second measurement result according to the first measurement result comprises:
predicting, based on a first configuration, the second measurement result according to the first measurement result.

5. The method according to claim 4, wherein the first configuration comprises at least one of the following:
allowing the user equipment to predict the second measurement result according to the first measurement result, or not allowing the user equipment to predict the second measurement result according to the first measurement result;
a correspondence between the first target and the second target;
a type of the first measurement result; or
a type of the second measurement result.

6. The method according to claim 4, further comprising:
receiving the first configuration sent by the network device.

7. The method according to claim 4, further comprising:
sending first information to the network device.

8. The method according to claim 7, wherein the first information comprises at least one of the following:
a cell or a beam for which the user equipment supports prediction; or
a type of a measurement result for which the user equipment supports prediction.

9. The method according to claim 1, wherein sending the second measurement result to the network device comprises:
sending the second measurement result that meets a reporting condition to the network device.

10. The method according to claim 9, wherein the reporting condition comprises at least one of the following:
an entering condition or a leaving condition based on an event;
the second target is a cell, and the second measurement result is a cell measurement result that meets a first preset condition on a frequency where the second target is located;
the second target is a beam, and the second measurement result is a beam measurement result that meets a second preset condition in a cell where the second target is located;
the second target is a measurement target cell;
the second target is a beam of the measurement target cell; or
the second target is a measurement target beam.

11. The method according to claim 1, further comprising at least one of the following:
sending, to the network device, a cell identifier or a beam identifier corresponding to the second measurement result;
sending second information to the network device, wherein the second information is configured to indicate that the second measurement result is a prediction result;
sending the first measurement result to the network device; or
sending a confidence value of the second measurement result to the network device.

12-14. (canceled)

15. A method for reporting a measurement, performed by a network device, the method comprising:
receiving a second measurement result sent by a user equipment, wherein the second measurement result is predicted according to a first measurement result, the first measurement result is a measurement result of a first target, and the second measurement result is a measurement result of a second target.

16. (canceled)

17. The method according to claim 15, further comprising:
sending a first configuration to the user equipment, wherein the first configuration is configured for the user equipment to predict, based on the first configuration, the second measurement result according to the first measurement result.

18. (canceled)

19. The method according to claim 17, wherein before sending the first configuration to the user equipment, the method further comprises:
receiving first information sent by the user equipment and determining the first configuration according to the first information.

20. (canceled)

21. The method according to claim 15, wherein receiving the second measurement result sent by the user equipment comprises:
receiving the second measurement result that meets a reporting condition sent by the user equipment.

22. (canceled)

23. The method according to claim 15, further comprising at least one of the following:
receiving a cell identifier or a beam identifier corresponding to the second measurement result that is sent by the user equipment;
receiving second information sent by the user equipment, wherein the second information is configured to indicate that the second measurement result is a prediction result;
receiving the first measurement result sent by the user equipment; or
receiving a confidence value of the second measurement result sent by the user equipment.

24-28. (canceled)

29. A user equipment, comprising:
one or more processors; and
a memory that stores processor-executable instructions, wherein
the processor-executable instructions, when collectively executed by the one or more processors, cause the user equipment to:
obtain a first measurement result, wherein the first measurement result is a measurement result of a first target;
predict a second measurement result according to the first measurement result, wherein the second measurement result is a measurement result of a second target; and
send the second measurement result to a network device.

30. A network device, comprising:
one or more processors; and
a memory that stores processor-executable instructions, wherein
the processor-executable instructions, when collectively executed by the one or more processors, cause the network device to perform the method according to claim 15.

31. (canceled)

32. A non-transitory computer-readable storage medium storing computer program instructions, wherein the computer program instructions, when collectively executed by one or more processors, cause the one or more processors to perform the method according to claim 1.

33. A non-transitory computer-readable storage medium storing computer program instructions, wherein the computer program instructions, when collectively executed by one or more processors, cause the one or more processors to perform the method according to claim 15.
